(19) United States
(12) Patent Application Publication
(10) Pub. No.: US 2014/0358775 A1
(43) Pub. Date: Dec. 4, 2014

(54) METHODS SYSTEMS AND COMPUTER PROGRAM PRODUCTS FOR ELECTRONIC BILL PAYMENT

(71) Applicant: Intuit Inc., Mountain View, CA (US)

(72) Inventor: Kevin Furbish, Palm Harbor, FL (US)

(21) Appl. No.: 13/907,584

(22) Filed: May 31, 2013

(51) Int. Cl. G06Q 20/14

(52) U.S. Cl. CPC G06Q 20/14
USPC 705/40

(57) ABSTRACT

Computer-implemented methods, systems and computer program products for automatic bill payment. The method includes receiving an electronic version of a bill at a bill receiver computer, the bill being received from a source through a network, wherein the bill is payable by a user, and has bill characteristics. The method also includes the bill receiver computer performing a comparison of the bill characteristics of the received bill with pre-determined guardrails associated with an account of the user. The method further includes the bill receiver computer determining whether the bill characteristics trigger a pre-determined guardrail based, at least in part, upon the comparison. Moreover, the method includes the bill receiver computer paying the received bill when the bill characteristics of the received bill do not trigger the pre-determined guardrail, else the bill receiver computer transmitting a request to authorize bill payment to a user computer.

### SUMMARY

Embodiments are directed to a computer-implemented method for automated bill payment. In one embodiment, the method comprises receiving an electronic version of a bill at a bill receiver computer, the bill being received from a source through a network. The bill is payable by a user and has bill characteristics. The method further comprises the bill receiver computer performing a comparison of the bill characteristics of the received bill with pre-determined guardrails associated with an account of the user. The method also comprises the bill receiver computer determining whether the bill characteristics trigger a pre-determined guardrail based, at least in part, upon the comparison. Moreover, the method comprises the bill receiver computer paying the received bill when the bill characteristics of the received bill do not trigger the pre-determined guardrail, else the bill receiver computer transmitting a request to authorize bill payment to a user computer. The bill receiver computer and the user computer may be the same computer or different computers.

A further embodiment is directed to an automated bill payment method implemented by a computer having a bill receiving module, a bill characteristics extraction module, a guardrail comparison module, an automatic payment module and a payment authorization module. The method comprises the bill receiving module receiving an electronic version of a bill at a bill receiver computer. The bill is received from a source through a network, is payable by a user, and has bill characteristics. The method further comprises the bill characteristics extraction module extracting the bill characteristics from the received bill. The method also comprises the guardrail comparison module performing a comparison the bill characteristics of the received bill with pre-determined guardrails associated with an account of the user. In addition, the method comprises the guardrail comparison module determining whether the bill characteristics trigger a pre-determined guardrail based, at least in part, upon the comparison. The method further comprises the automatic payment module paying the received bill when the bill characteristics of the received bill do not trigger the pre-determined guardrail, else the payment authorization module displaying a user interface object configured to authorize bill payment with a single selection on a user interface. The bill characteristics extraction module may extract the bill characteristics from the received bill by screen scraping.

A further embodiment is directed to a computer-implemented method for automated bill payment that comprises receiving an electronic version of a bill, at a computer of a host of an account of a debtor, The bill is received from a source through a network, is payable by the debtor and has bill characteristics. The method further comprises the host computer performing a comparison of the bill characteristics of the received bill with pre-determined guardrails associated with the debtor account. The method also comprises the host computer determining whether the bill characteristics trigger a pre-determined guardrail based, at least in part, upon the comparison. The method further comprises, when the bill characteristics of the received bill do not trigger the pre-determined guardrail, the host computer automatically paying the received bill, else the host computer transmitting a request to authorize bill payment to the user.

Further embodiments are directed to articles of manufacture or computer program products comprising a non-transitory computer readable storage medium embodying one or more instructions executable by a computer to perform automated bill payment process according to embodiments. One process comprises receiving an electronic version of a bill at a bill receiver computer from a source through a network. The bill is payable by a user and has bill characteristics, and performing a comparison of the bill characteristics of the received bill with pre-determined guardrails associated with an account of the user. The process further comprises the bill receiver computer determining whether the bill characteristics trigger a pre-determined guardrail based, at least in part, upon the comparison, and the bill receiver computer paying the received bill when the bill characteristics of the received bill do not trigger the pre-determined guardrail, else the bill receiver computer transmitting a request to authorize bill payment to a user computer.

Yet another embodiment is directed to an article of manufacture or computer program product comprising a non-transitory computer readable storage medium embodying one or more instructions executable by a computer having a bill receiving module, a bill characteristics extraction module, a guardrail comparison module, an automatic payment module and a payment authorization module to perform a process for automated bill payment, the process comprising the bill receiving module receiving an electronic version of a bill at a bill receiver computer, the bill being received from a source through a network, wherein the bill is payable by a user, and has bill characteristics, the bill characteristics extraction module extracting the bill characteristics from the received bill; the guardrail comparison module performing a comparison of the bill characteristics of the received bill with pre-determined guardrails associated with an account of the user, the guardrail comparison module determining whether the bill characteristics trigger a pre-determined guardrail based, at least in part, upon the comparison, and the automatic payment module paying the received bill when the bill characteristics of the received bill do not trigger the pre-determined guardrail, else the payment authorization module displaying a user interface object configured to authorize bill payment with a single selection on a user interface.

A further embodiment is directed to an article of manufacture or computer program product comprising a non-transitory computer readable storage medium embodying one or more instructions executable by a computer to perform a process for automated bill payment, the process comprising receiving an electronic version of a bill, at a computer of a host of an account of a debtor, the bill being received from a source through a network, wherein the bill is payable by the debtor, and has bill characteristics, the host computer performing a comparison of the bill characteristics of the received bill with pre-determined guardrails associated with the debtor account, the host computer determining whether the bill characteristics trigger a pre-determined guardrail based, at least in part, upon the comparison, and when the bill characteristics of the received bill do not trigger the pre-determined guardrail, the host computer automatically paying the received bill, else the host computer transmitting a request to authorize bill payment to the user.

In a single or multiple embodiments, the bill receiver computer, bill receiving module, or host computer may communicate with a bill sender computer through a secure network having built-in identity authentication. The bill receiver computer and the host computer may also send the request to authorize bill payment to the user computer or user through a network. The various user computers may be mobile computers. The methods or processes may also comprise the bill receiver computer or the automatic payment module updating a financial database after automatically paying the received bill.

A single or multiple embodiments may involve, generate or cause the user computer to display, in response to the request to authorize bill payment, a user interface object configured to authorize bill payment with a single selection on a user interface. The user computer may comprise a touch-screen interface, wherein the single selection on the user interface is a single touch of the user interface object. The user interface object may comprise the bill characteristics of the received bill. The bill characteristics may be selected from the group consisting of payee identity, payee category, bill amount, bill frequency, due date, past due amount, and description of services or goods purchased. The user interface object may also comprise a button configured to authorize payment of the received bill when the button is selected.

### BRIEF DESCRIPTION OF THE DRAWINGS

The foregoing and other aspects of embodiments are described in further detail with reference to the accompanying drawings, in which the same elements in different figures are referred to by common reference numerals, wherein:

FIG. 1 is a block diagram of one embodiment of a system configured for automatic bill payment;

FIG. 2 depicts an interface that may be utilized as part of an automatic bill payment system;

FIG. 3 is a block diagram of another embodiment of a system configured for automatic bill payment;

FIG. 4 is a flow diagram of one embodiment of a method for automatic bill payment;

FIG. 5 is an exemplary table containing bill characteristics for use in automatic bill payment embodiments;

FIG. 6 depicts another interface that may be utilized as part of an automatic bill payment system.

FIG. 7 is a flow diagram of another embodiment of a method for automatic bill payment.

FIG. 8 is a block diagram of a computing apparatus or system in which various embodiments may be implemented or that may be utilized to execute various embodiments.

In order to better appreciate how to obtain the above-recited and other advantages and objects of various embodiments, a more detailed description of embodiments is provided with reference to the accompanying drawings. It should be noted that the drawings are not drawn to scale and that elements of similar structures or functions are represented by like reference numerals throughout. It will be understood that these drawings depict only certain illustrated embodiments and are not therefore to be considered limiting of scope of embodiments.

### DETAILED DESCRIPTION OF ILLUSTRATED EMBODIMENTS

The bill payment system described herein facilitates automated bill payment. A bill sender computer delivers an electronic bill to a bill receiver computer. The bill receiver computer then compares bill characteristics of the bill to “guardrails” (i.e., user pre-set conditions that would prevent automatic bill payment). If the bill characteristics do not trigger any of the guardrails, the bill is automatically paid. If the bill characteristics trigger any of the guardrails, a message is sent to the user requesting authorization to pay the bill. Automatic bill payment reduces the demand on user time for paying bills.

A bill payment authorization request may be sent to a user's smartphone. The request includes a user interface object configured to authorize bill payment with a single selection by the user. The user's smartphone authentication serves as a proxy for user login, thereby further reducing the demand on user time for paying bills without compromising account security.

As used in this application, “bill” includes, but is not limited to, an amount due to satisfy a debtor's financial obligation, whether before or after a due date, including, but not limited to, a credit card payment, a tuition payment, a utility payment (e.g., gas and electric, water, or trash), a payment to a merchant (e.g., an invoice or debit), and a loan payment (e.g., mortgage, auto, or education). For instance, a “bill” can include a payment to a credit card account to reduce an account balance that is approaching the account limit before the end of a billing cycle and before the credit card company issues an actual bill.

As used in this application, “debtor” includes, but is not limited to, someone who owes money to a payee or creditor such as an account holder (e.g., credit card holder), student, other person or entity that is legally obligated to pay, responsible for payment to, or that has contractually agreed to pay, a creditor or payee. As used in this application, “payee” includes, but is not limited to, someone to whom money is owned by a debtor, such as a merchant (brick and mortar and online), a utility, a credit card company, a financial institution, or a service providers. As used in this application, “computer” includes, but is not limited to, a computer (laptop or desktop), mobile communication device, smartphone and tablet computing device such as an iPad®.

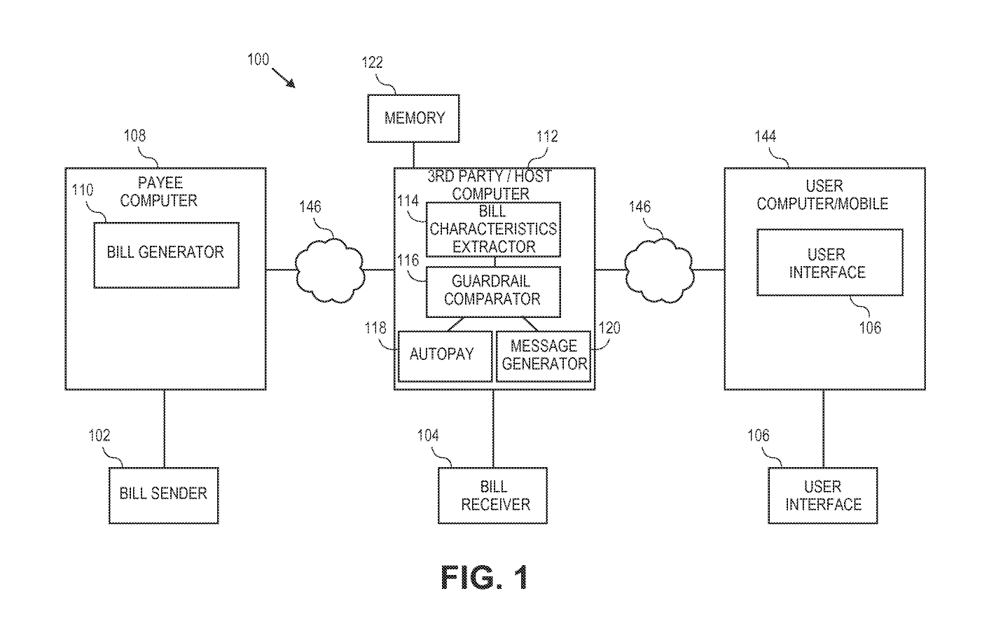

Referring to FIG. 1, an automatic bill payment system 100 constructed according to one embodiment includes or involves operatively connected software modules, programs, or applications: (1) a bill/invoice sender 102; (2) a bill/invoice receiver 104; and (3) a user interface 106. System embodiments provide for automatic bill payment, saving users (i.e., debtors) time while allowing them to determine the bills that are automatically paid. The bill sender 102 depicted in FIG. 1 runs on a payee computer 108 and includes a bill generator module 110 that generates an electronic invoice/bill, including bill characteristics such as a payee, an amount due, and a due date. An exemplary bill sender is a financial management system or host thereof such as QUICKBOOKS financial management system, available from Intuit Inc., Mountain View, Calif. QUICKBOOKS is a registered trademark of Intuit Inc. A payee computer 108 may be a computer of a merchant, a utility or other entity to which payment is owed by the payor. Third party accounting and billing systems can deliver bills through the bill sender 102 by means of a known application programming interface (“an API”).

Payees may belong to the secure networks having built-in identity authentication, such as the Commerce Network™ payment network of Intuit Inc, for ease of identifying billing entities and disambiguation. The Commerce Network™ payment network authenticates the identities of billing entities (i.e., payees) and makes them discoverable to other entities (e.g., consumers, small businesses, and financial institutions).

With continuing reference to FIG. 1, the bill receiver 104 executes on a host computer 112 belonging to a third party host or intermediate party, such as Intuit Inc. The host computer 112 may host an account of the debtor. The host 208 may offer on-line banking services such that the debtor accesses the account hosted by the financial institution through the host computer 112.

According to one embodiment, the bill receiver 104 includes the following interconnected modules: a bill characteristics extraction module 114; a guardrail comparison module 116; an automatic payment module 118; and a message generator module 120. The functions of these modules will be described below. In the illustrated embodiment, the bill receiver 104 is also connected to a memory module 122 that stores data to be accessed and modified by the system 100 such as user account information and user “guiderails” (described below). Although the memory module 122 is depicted as outside of the host computer 112, the memory module 122 can be located in the host computer 112 in other embodiments.

As described herein, “guardrails” control the types of bills that will be automatically processed and paid. Guardrails may include the identities or categories of payees for which bills can be automatically paid, the maximum bill amount that can be automatically paid (globally, per-payee, or per-payee-category), the frequency with which bills can be automatically paid (per-payee), the due date range for which bills can be automatically paid (globally, per-payee, or per-payee-category), the amount past due (per payee) on bills that can be automatically paid, the services or goods for which bill can be automatically paid.

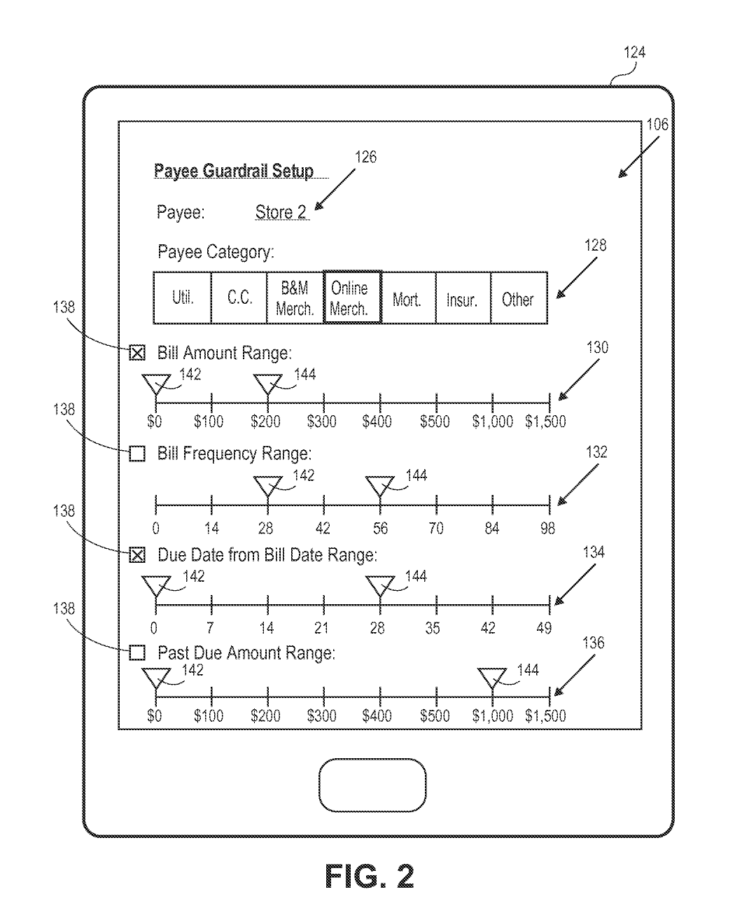

Referring to FIG. 2, a user computer 124 displays a user interface 106 generated according to embodiments for setting the guardrails for a particular payee. In the illustrated embodiment, the user computer 124 is a mobile communication or computing device, in particular, a smartphone. While reference is made to a smartphone, it will be understood that embodiments may involve or be executed on various other communication and computing devices including, for example, tablet devices such as the IPAD available from Apple, Inc. The user interface 124 includes a payee field 126 for entering the name of the payee. The user interface 124 also includes a payee category menu 128 for selecting the category of the identified payee. While the payee category menu 128 is depicted as a static menu, it can also be a drop-down menu.

The user interface 124 further includes selectors for the following optional guardrails: a bill amount range selector 130; a bill frequency range selector 132; a due date from bill date selector 134; and a past due amount selector 136. These optional guardrails set respective ranges of bill amounts, bill frequency, due dates, and past due amounts for bills that will be automatically paid by the system 100. The optional guardrails can be activated with activation buttons 138 displayed on the user interface 106 adjacent each optional guardrail label. The ranges can be adjusted using minimum and maximum sliders 140, 142. While sliders 140, 142 are shown in FIG. 2, these ranges can be adjusted using other interface objects, such as drop down menus, in other embodiments. Once the user sets the guardrails, they are stored in the memory module 122 and accessible to the bill receiver 104. While FIG. 2 depicts a user interface 106 for configuring a particular set of four optional guardrails for a specific payee, the user interface 106 may control other larger or smaller sets of optional guardrails. Moreover, the user interface 106 may control optional guardrails for a payee category instead of a particular payee.

Referring again to FIG. 1, the user interface 106 executes on a user computer 144, which in the depicted embodiment is a mobile communication or computing device such as a smartphone. On such a smartphone, the user interface 106 generated according to embodiments may be part of an application, or “app.” This may be the same application used to set the guardrails for payees, as shown in FIG. 2 and described above. Alternatively, one or both of these functions may be performed by software running on a personal computer or accessible through the internet via a browser. The user interface 106 is configured to authorize bill payments and will be described in greater detail below. In the embodiment depicted in FIG. 1, the host computer 112 and the user computer 144 are different computers.

The bill receiver 104 is connected to both the bill sender 102 the user interface 106 via networks 146 having built-in identity authentication, such as the Commerce Network™ payment network. While the networks depicted in FIG. 1 have built-in identity authentication, the system 100 may also function, though not a sufficiently, with networks that do not have built-in identity authentication. Other examples of networks 146 that may be utilized for communications between system 100 components include but are not limited to a Local Area Network (LAN), a Wide Area Network (WAN), Metropolitan Area Network (MAN), a wireless network, other suitable networks capable of transmitting data, and a combination one or more or other networks. For ease of explanation, reference is made to a network 146 generally, but various networks 146, combinations of networks 146 and communication systems, methods and protocols may be utilized. When needed, the debtor/user may utilize a computer such as a desktop or laptop computer, a tablet computing device, a smartphone or other mobile or computing device capable of communicating with host computer 112 through these networks 146, and may utilize a browser to navigate screens presented to view and manage a debtor/user account.

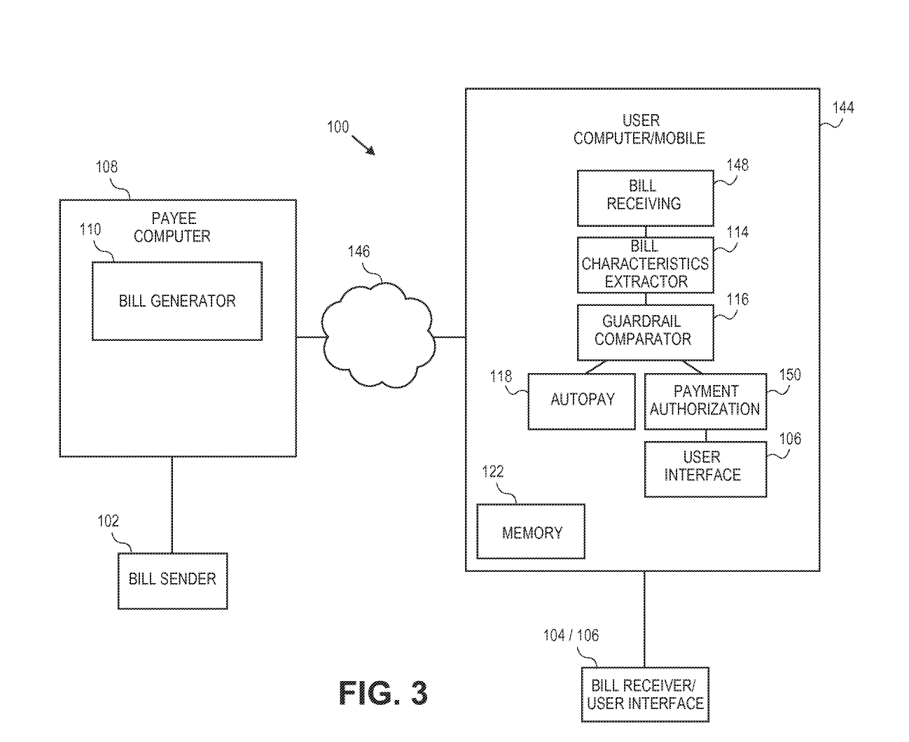

In the embodiment shown in FIG. 3, both the bill receiver 104 and the user interface 106 run on the same user computer 144. In this embodiment, the user computer 144 is a mobile computer, such as a smart phone. In other embodiments, the user computer 144 may be a personal computer. On a smartphone, the bill receiver 104 and the user interface 106 may be part of a bill receiver/user interface application. According to one embodiment, this application may include various modules: a bill receiving module 148, a bill characteristics extraction module 114; a guardrail comparison module 116; an automatic payment module 118; a payment authorization module 150; and a user interface 106. The bill receiver/user interface application also includes a memory module 122 as described above. Although the memory module 122 is depicted as inside of the user computer 144, the memory module 122 can be located outside of the user computer 144 in other embodiments.

Having described various aspects of embodiments of the automatic bill payment system 100, computer−=implemented methods for automatically paying bills using the systems 100 will now be described. Before the systems 100 may be used to automatically pay bills, a user installs the program/application and provides the program/application with financial (e.g., checking account, credit card account, or online transfer account) information to be used to pay bills. Checking account information may include a checking account number and a routing number. Credit card account information may include an account number, an expiration date, and a card verification value (“CVV”). Online transfer account information may include an account ID (e.g., a PAYPAL ID) and a password. The user also establishes “guardrails” that control the types of bills that will be automatically processed and paid, as described above.

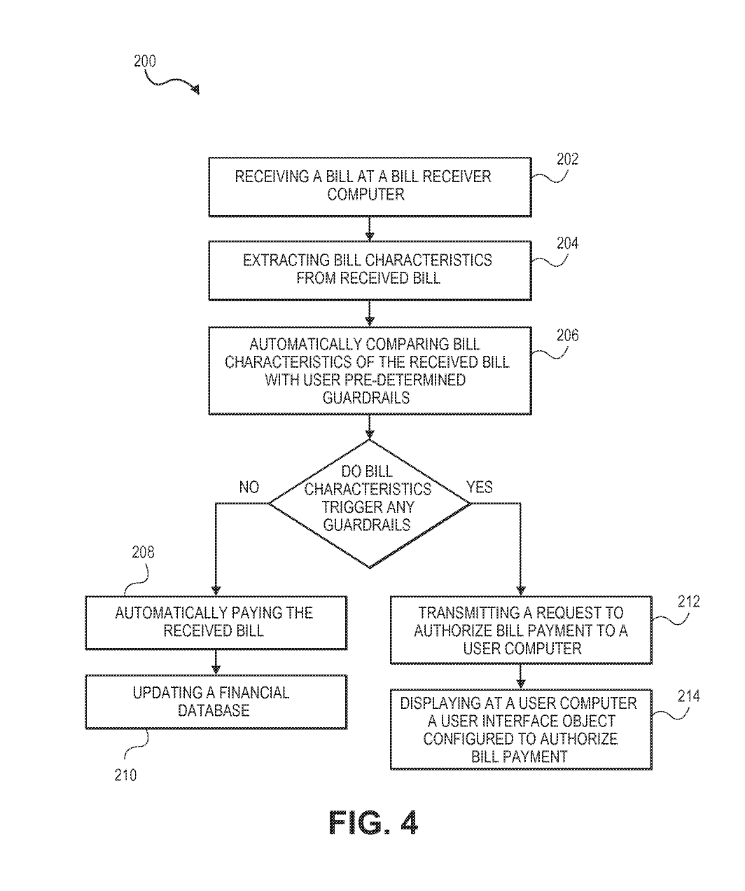

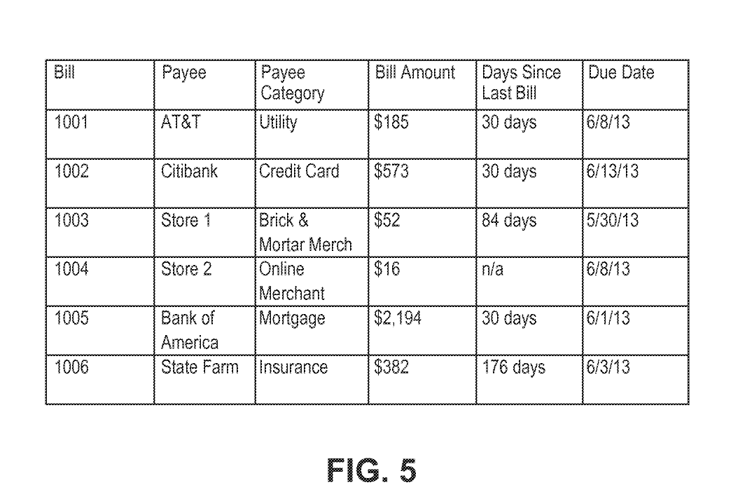

Referring to FIG. 4, in a method for automatically paying bills according to one embodiment using system components described above, at 202, the bill receiver computer/host computer 112 receives a bill from a payee. As described above, the host computer may host a financial account of the debtor. The bill may be delivered through a network having built-in identity authentication such as the Commerce Network™. At 204, the bill characteristics extraction module 114 extracts the characteristics of the received bill, for instance, by screen scraping the received bill. The extracted bill characteristics may be stored in the memory module 122 in the form of a table, as depicted in FIG. 5. At 206, the guardrail comparison module 116 automatically compares the extracted bill characteristics with the guardrails that have been predetermined by the user. When the extracted bill characteristics do not trigger any of the guardrails, the automatic payment module 118 automatically pays the received bill, at step 208, using the financial information previously provided by the user. Optionally, the automatic payment module 118 can update a financial database with information regarding the automatic bill payment, at step 210. When the extracted bill characteristics trigger any of the guardrails, the message generator module 120 transmits a request authorize bill payment to the user computer 144, at step 212. In response to the received bill payment authorization request, the user computer 144 displays, at step 214, a user interface object 152 on its user interface 106.

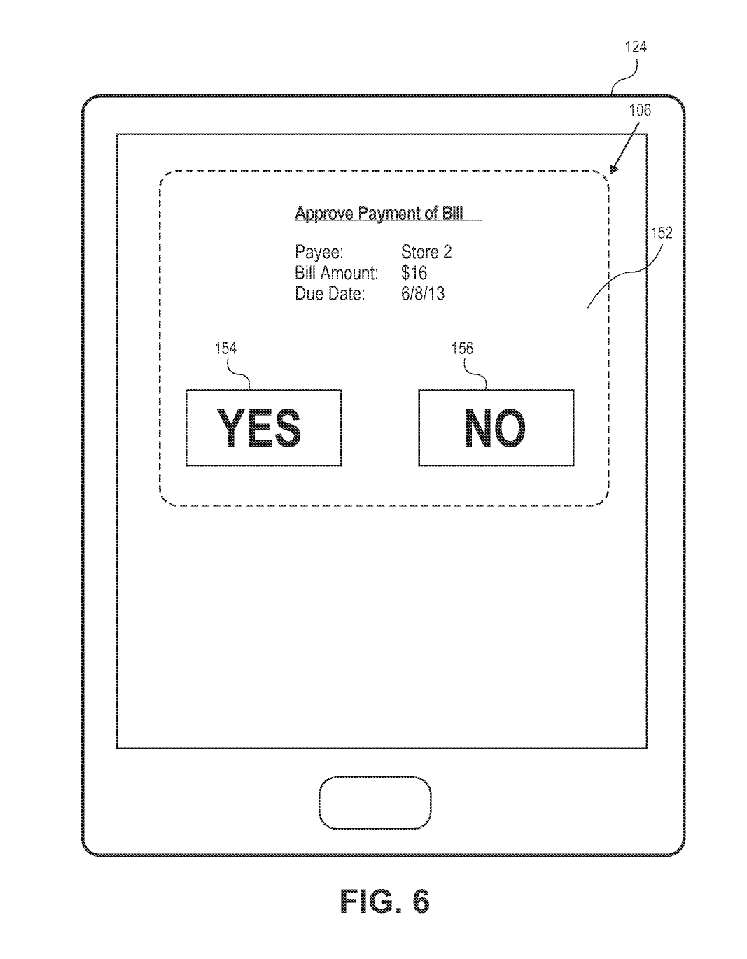

As shown in FIG. 6, the user interface object 152 is configured to authorize bill payment with a single selection on the user interface 106. In the embodiment depicted in FIG. 6, the user computer 144 is a mobile computer, such as a smart phone, and the user interface 106 includes a touch-screen interface. Accordingly, the user interface object 152 is configured to authorize bill payment with a single touch of the user interface object 152 displayed in the user interface 106. The user interface object 152 includes some of the extracted bill characteristics of the received bill. The user interface object 152 also includes two buttons 154, 156 configured to authorize or decline bill payment, respectively. If the user touches the “YES” button 154, the user computer 124 will send a message to the third-party computer 112 authorizing bill payment. If the user touches the “NO” button 156, the received bill will not be paid at that time.

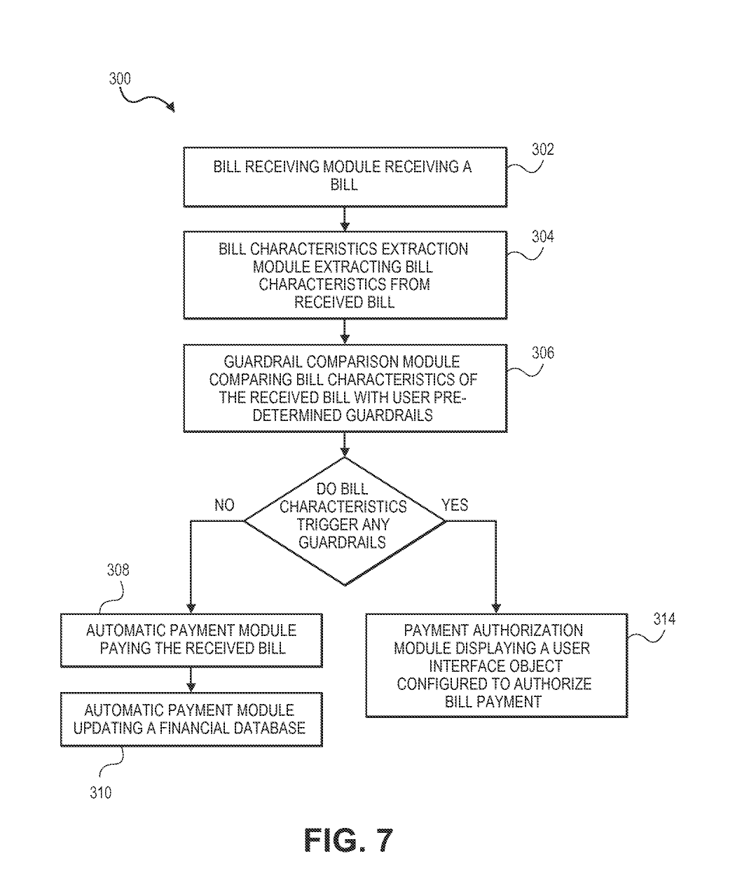

Referring to FIG. 7, a method 300 for automatically paying bills using system components described above involves or comprise, at 302, the bill receiving module 148 receives a bill from a payee. The bill may be delivered through a network having built-in identity authentication such as the Commerce Network™. At 304, the bill characteristics extraction module 114 extracts the characteristics of the received bill, for instance, by screen scraping the received bill. The extracted bill characteristics may be stored in the memory module 122 in the form of a table, as depicted in FIG. 5. At 306, the guardrail comparison module 116 automatically compares the extracted bill characteristics with the guardrails that have been predetermined by the user. If the extracted bill characteristics do not trigger any of the guardrails, the automatic payment module 118 automatically pays the received bill, at 308, using the financial information previously provided by the user. Optionally, the automatic payment module 118 can update a financial database with information regarding the automatic bill payment, at 310. If the extracted bill characteristics trigger any of the guardrails, the payment authorization module 150 displays, at 314, a user interface object 152 on its user interface 106. The user interface object 152 is shown in FIG. 6, and its function is described above.

As describe above, a bill that triggers any of these guardrails will not be automatically paid, but will instead be presented to the user for authorization via a smartphone. Using a smartphone to authenticate bill payments eliminates the need for users to login to make a payment as they do when using an online bill pay application. Many smartphones have operating systems with built-in authentication or login functions. Alternatively, the bill receiver 104, the user interface 106, or an operatively connected, but independent program/application can perform the authentication function. Bypassing user login, and using a smartphone's built-in authentication or login functions, further reduces user time spent on paying bills. The software performing the authentication function (e.g., operating system, bill receiver, or authentication application) may also include a remotely activated disabling function to prevent unauthorized access to financial accounts should a smartphone be lost or stolen.

As described above, when the user computer 144 displays a user interface object 152 in either the methods depicted in FIGS. 4 and 7, a user can then view the bill characteristics and authorize payment with a single selection on the user interface 124. There is no need to login to a separate payment application or to enter the bill characteristics (e.g., amount to pay and who to pay), because that data has already been provided to the automatic bill payment system 100.

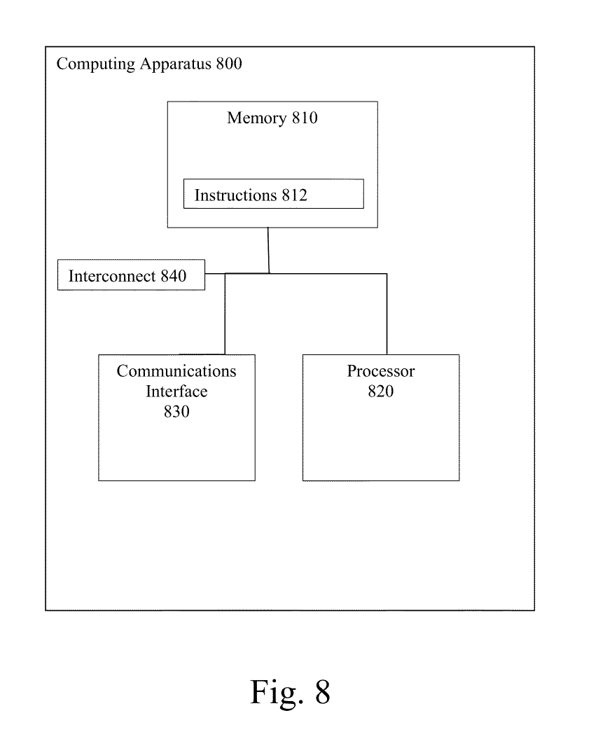

FIG. 8 generally illustrates certain components of a computing device 800 that may be utilized to execute embodiments and that includes a memory 810, program instructions 812, a processor or controller 820 to execute instructions 812, a network or communications interface 830, e.g., for communications with a network or interconnect 840 between such components. The memory 810 may be or include one or more of cache, RAM, ROM, SRAM, DRAM, RDRAM, EEPROM and other types of volatile or non-volatile memory capable of storing data. The processor unit 820 may be or include multiple processors, a single threaded processor, a multi-threaded processor, a multi-core processor, or other type of processor capable of processing data. Depending on the particular system component (e.g., whether the component is a computer or a hand held mobile communications device), the interconnect 840 may include a system bus, LDT, PCI, ISA, or other types of buses, and the communications or network interface may, for example, be an Ethernet interface, a Frame Relay interface, or other interface. The network interface 830 may be configured to enable a system component to communicate with other system components across a network which may be a wireless or various other networks. It should be noted that one or more components of computing device 1500 may be located remotely and accessed via a network. Accordingly, the system configuration provided in FIG. 8 is provided to generally illustrate how embodiments may be configured and implemented.

Method embodiments or certain steps thereof, some of which may be loaded on certain system components, computers or servers, and others of which may be loaded and executed on other system components, computers or servers, may also be embodied in, or readable from, a non-transitory, tangible medium or computer-readable medium or carrier, e.g., one or more of the fixed and/or removable data storage data devices and/or data communications devices connected to a computer. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, DVD-RW, or other carrier now known or later developed capable of storing data. The processor 820 performs steps or executes program instructions 812 within memory 810 and/or embodied on the carrier to implement method embodiments.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

While multiple embodiments and variations of aspects of the invention have been disclosed herein, such disclosure is provided for purposes of illustration only. Where methods and steps described above indicate certain events occurring in certain order, those of ordinary skill in the art having the benefit of this disclosure would recognize that the ordering of certain steps may be modified and that such modifications are in accordance with the variations of the invention. Additionally, certain of the steps may be performed concurrently in a parallel process as well as performed sequentially. Thus, the methods shown in various flow diagrams are not intended to be limited to a particular sequential order, particularly in instances in which certain steps may or may not be performed. Accordingly, embodiments are intended to exemplify alternatives, modifications, and equivalents that may fall within the scope of the claims.

What is claimed is:

1. A computer-implemented method for automated bill payment, the method comprising:
receiving an electronic version of a bill at a computer, the bill being received from a source through a network, wherein the bill is payable by a user, and has bill characteristics;
the computer performing a comparison of the bill characteristics of the received bill with pre-determined guardrails associated with an account of the user;
the computer determining whether the bill characteristics trigger a pre-determined guardrail based, at least in part, upon the comparison; and
the computer paying the received bill when the bill characteristics of the received bill do not trigger the pre-determined guardrail, else the computer transmitting a request to authorize bill payment to a user computer.

2. The method of claim 1, wherein the computer communicates with a bill sender computer through a secure network having built-in identity authentication.

3. The method of claim 1, further comprising the user computer displaying, in response to the request to authorize bill payment, a user interface object configured to authorize bill payment with a single selection on a user interface.

4. The method of claim 3, wherein the user computer comprises a touch-screen interface, and wherein the single selection on the user interface is a single touch of the user interface object.

5. The method of claim 3, wherein the user interface object comprises the bill characteristics of the received bill.

6. The method of claim 5, wherein the bill characteristics are selected from the group consisting of payee identity, payee category, bill amount, bill frequency, due date, past due amount, and description of services or goods purchased.

7. The method of claim 3, wherein the user interface object comprises a button configured to authorize payment of the received bill when the button is selected.

8. The method of claim 1, wherein the user computer is a mobile communication device.

9. The method of claim 1, further comprising the computer sending the request to authorize bill payment to the user computer through a network.

10. The method of claim 1, wherein the bill characteristics are selected from the group consisting of payee identity, payee category, bill amount, bill frequency, due date, past due amount, and description of services or goods purchased.

11. The method of claim 1, further comprising the computer updating a financial database after automatically paying the received bill.

12. The method of claim 1, wherein the computer and the user computer are the same computer.

13. The method of claim 1, wherein the computer and the user computer are different computers.

14. A computer-implemented method for automated bill payment implemented in a computer comprising a bill receiving module, a bill characteristics extraction module, a guardrail comparison module, an automatic payment module and a payment authorization module, the method comprising:
the bill receiving module receiving an electronic version of a bill at a computer, the bill being received from a source through a network, wherein the bill is payable by a user, and has bill characteristics;
the bill characteristics extraction module extracting the bill characteristics from the received bill;
the guardrail comparison module performing a comparison of the bill characteristics of the received bill with pre-determined guardrails associated with an account of the user;
the guardrail comparison module determining whether the bill characteristics trigger a pre-determined guardrail based, at least in part, upon the comparison; and
the automatic payment module paying the received bill when the bill characteristics of the received bill do not trigger the pre-determined guardrail, else the payment authorization module displaying a user interface object configured to authorize bill payment with a single selection on a user interface.

15. The method of claim 14, wherein the bill receiving module communicates with a bill sender computer through a secure network having built-in identity authentication.

16. The method of claim 14, wherein the computer comprises a touch-screen interface, and wherein the single selection on the user interface is a single touch of the user interface object.

17. The method of claim 14, wherein the user interface object comprises the bill characteristics of the received bill.

18. The method of claim 17, wherein the bill characteristics are selected from the group consisting of payee identity, payee category, bill amount, bill frequency, due date, past due amount, and description of services or goods purchased.

19. The method of claim 14, wherein the user interface object comprises a button configured to authorize payment of the received bill when the button is selected.

20. The method of claim 14, wherein the computer is a mobile computer.

21. The method of claim 14, wherein the bill characteristics are selected from the group consisting of payee identity, payee category, bill amount, bill frequency, due date, past due amount, and description of services or goods purchased.

22. The method of claim 14, further comprising the automatic payment module updating a financial database after automatically paying the received bill.

23. The method of claim 14, wherein the bill characteristics extraction module extracts the bill characteristics from the received bill by screen scraping.

24. A computer-implemented method for automated bill payment, the method comprising:
receiving an electronic version of a bill, at a computer of a host of an account of a debtor, the bill being received from a source through a network, wherein the bill is payable by the debtor, and has bill characteristics;
the host computer performing a comparison of the bill characteristics of the received bill with pre-determined guardrails associated with the debtor account;
the host computer determining whether the bill characteristics trigger a pre-determined guardrail based, at least in part, upon the comparison; and
when the bill characteristics of the received bill do not trigger the pre-determined guardrail, the host computer automatically paying the received bill, else the host computer transmitting a request to authorize bill payment to the user.

25. The method of claim 24, further comprising displaying at the user computer, in response to the request to authorize bill payment, a user interface object configured to authorize bill payment with a single selection on a user interface.

26. A computer program product comprising a non-transitory computer readable storage medium embodying one or more instructions executable by a computer to perform a process for automated bill payment, the process comprising receiving a bill at a computer, wherein the bill is payable by a user, and wherein the bill has bill characteristics, automatically comparing the bill characteristics of the received bill with pre-determined guardrails associated with an account of the user, and automatically paying the received bill when the bill characteristics of the received bill do not trigger any of the pre-determined guardrails, else transmitting a request to authorize bill payment to a user computer.

27. A computer program product comprising a non-transitory computer readable storage medium embodying one or more instructions executable by a computer having a bill receiving module, a bill characteristics extraction module, a guardrail comparison module, an automatic payment module and a payment authorization module to perform a process for automated bill payment, the process comprising the bill receiving module receiving a bill payable by a user, the bill having bill characteristics, the bill characteristics extraction module extracting the bill characteristics from the received bill, the guardrail comparison module comparing the bill characteristics of the received bill with pre-determined guardrails associated with an account of the user, and the automatic payment module automatically paying the received bill when the bill characteristics of the received bill do not trigger any of the pre-determined guardrails, else the payment authorization module displaying a user interface object configured to authorize bill payment with a single selection on a user interface.

28. A computer program product comprising a non-transitory computer readable storage medium embodying one or more instructions executable by a computer to perform a process for automated bill payment, the process comprising receiving, at a computer of a host of an account of a debtor, a bill payable by the debtor and having bill characteristics, the host computer automatically comparing the bill characteristics of the received bill with pre-determined guardrails associated with the debtor account, and when the bill characteristics of the received bill do not trigger any of the pre-determined guardrails, the host computer automatically paying the received bill, else the host computer transmitting a request to authorize bill payment to the user.
